(19) United States
(12) Patent Application Publication
(10) Pub. No.: US 2025/0173733 A1
(43) Pub. Date: May 29, 2025

(54) ATTENTION-BASED DEEP NEURAL ARCHITECTURES FOR MULTI-POINT RESPONSE GENERATION IN VIRTUAL BUSINESS ASSISTANT AI ENGINES

(71) Applicants: SRIVATSAN LAXMAN, PALO ALTO, CA (US); SRAVANTHI MUTYALA, BENGALURU (IN); HRUDAY GOWDA, BENGALURU (IN); SRIKHAR PADMANABHAN, PALO ALTO, CA (US); SUPRIYA RAO, PALO ALTO, CA (US)

(72) Inventors: SRIVATSAN LAXMAN, PALO ALTO, CA (US); SRAVANTHI MUTYALA, BENGALURU (IN); HRUDAY GOWDA, BENGALURU (IN); SRIKHAR PADMANABHAN, PALO ALTO, CA (US); SUPRIYA RAO, PALO ALTO, CA (US)

(21) Appl. No.: 18/519,073

(22) Filed: Nov. 27, 2023

(51) Int. Cl. G06Q 30/015

(52) U.S. Cl. CPC G06Q 30/015

(57) ABSTRACT

In one aspect, a computerized-method for implementing a unified model that responds to an incoming customer message or request, comprising: given a user input message, U: identifying a response, R, that is to be sent to the customer, identifying a business notification, B, that is to be sent to the staff at the business, basing the response, R, and the business notification, B, on a common template or a business-specific template or a canned response defined by the business; wherein a unique (R,B) pair comprises a potential response to the input user message, U, storing a plurality of (R,B) pairs in a Document Store that is accessible through an Information Retrieval System; alongside the plurality of (R,B) pairs, storing a set of examples and a set of variations of the customer query, Q, for which each (R,B) pair of the plurality of (R,B) pairs is the appropriate response; given a query, Q: providing a plurality of corresponding (Q,R,B) triples.

### BACKGROUND

It is noted that, in the context of a virtual assistant for local (e.g. brick and mortar) businesses, an AI engine should, inter alia: (i) accurately understand and interpret customer requests (ii) access relevant systems of record that the business uses, (iii) define and send suitable responses to the customer, (iv) update systems of record based on the responses, wherever needed, and finally, (v) coordinate with staff at the business, in real-time, by providing accurate summaries of the AI's interactions with a customer and also by notifying the staff of any tasks/to-do's that are outstanding with respect to the customer. In some example application settings, one needs to instantly spin-up deeply-integrated high-fidelity, custom, virtual assistants per business, for thousands of different businesses, each with unique business workflows for use-cases ranging from customer support and account management to sales and marketing. Moreover, in such application settings, the solution must also automatically build and deploy such virtual assistants without requiring any retraining whatsoever of the foundational AI models, because there is very limited (if any) business-specific training data sets to train and tune each business-specific AI model.

### SUMMARY OF THE INVENTION

In one aspect, a computerized-method for implementing a unified model that responds to an incoming customer message or request, comprising: given a user input message, U: identifying a response, R, that is to be sent to the customer, identifying a business notification, B, that is to be sent to the staff at the business, basing the response, R, and the business notification, B, on a common template or a business-specific template or a canned response defined by the business; wherein a unique (R,B) pair comprises a potential response to the input user message, U, storing a plurality of (R,B) pairs in a Document Store that is accessible through an Information Retrieval System; alongside the plurality of (R,B) pairs, storing a set of examples and a set of variations of the customer query, Q, for which each (R,B) pair of the plurality of (R,B) pairs is the appropriate response; given a query, Q: providing a plurality of corresponding (Q,R,B) triples, wherein all the different Q's but same (R,B) are organized in the Document Store under a single, unique, cluster; wherein given user input message, U, retrieving a best (Q,R,B) triple using an information retrieval system that matches user input message, U with the Q of the (Q,R,B) triple; and passing the user input message, U together with each candidate (Q,R,B) triple through a multi-head attention-based binary classifier to determine if the candidate represents a response that is to be sent to the business and the user.

### BRIEF DESCRIPTION OF THE DRAWINGS

FIG. 1 illustrates an example of process for an attention-based deep neural network architecture for automating communications between a business and its customers, according to some embodiments.

FIG. 2 illustrates an example of UQRB classifier, according to some embodiments.

FIG. 3 illustrates an example process for implementing a UQRB classifier, according to some embodiments.

FIG. 4 illustrates an example process for candidate generation, according to some embodiments.

FIG. 5 illustrates an example process for keywords-based filtering, according to some embodiments.

FIG. 6 illustrates an example process related to keywords-based filtering, according to some embodiments.

FIG. 7 illustrates an example UQRB Network Architecture, according to some embodiments.

FIG. 8 illustrates an example process for Model Training, according to some embodiments.

FIGS. 9 and 10 illustrate example Precision-Recall Curves, according to some embodiments and provided by way of example and not of limitation.

The Figures described above are a representative set and are not exhaustive with respect to embodying the invention.

### DESCRIPTION

Disclosed are a system, method, and article of manufacture for attention-based deep neural architectures for multi-point response generation in virtual business assistant AI engines. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Chatbot is a computer program or an artificial intelligence which conducts a conversation via auditory or textual methods.

Deep neural network (DNN) is an artificial neural network (ANN) with multiple layers between the input and output layers. The DNN finds the correct mathematical manipulation to turn the input into the output, whether it be a linear relationship or a non-linear relationship. The network moves through the layers calculating the probability of each output. For example, a DNN that is trained to recognize dog breeds will go over the given image and calculate the probability that the dog in the image is a certain breed. The user can review the results and select which probabilities the network can display (e.g. above a certain threshold, etc.) and return the proposed label.

Dense layer (e.g. a fully-connected layer) refers to a layer whose inside neurons connect to every neuron in the preceding layer.

Directed acyclic graph (DAG) is a finite directed graph with no directed cycles. It can include a finite number of vertices and edges. Each edge can be directed from one vertex to another, such that there is no way to start at any vertex v and follow a consistently-directed sequence of edges that eventually loops back to v again. A directed acyclic graph can be a directed graph that has a topological ordering, a sequence of the vertices such that every edge is directed from earlier to later in the sequence.

Feature vector can be an organization of information provided by a set of descriptors as the elements of one single vector.

GloVe, coined from Global Vectors, is a model for distributed word representation. The model is an unsupervised learning algorithm for obtaining vector representations for words. This is achieved by mapping words into a meaningful space where the distance between words is related to semantic similarity. Training is performed on aggregated global word-word co-occurrence statistics from a corpus, and the resulting representations showcase interesting linear substructures of the word vector space.

Semantic frame can be a collection of facts that specify characteristic features, attributes, and functions of a denotatum, and its characteristic interactions with things necessarily or typically associated with it. The semantic frame captures specific pieces of information that are relevant to summarizing and driving a goal-oriented conversation.

SoftMax function converts a vector of K real numbers into a probability distribution of K possible outcomes. The SoftMax function can be a generalization of the logistic function to multiple dimensions and used in multinomial logistic regression.

Tokenization can include the process of breaking a stream of text up into words, phrases, symbols, or other meaningful elements called tokens which represent the basic unit processed by the NLP system. The list of tokens becomes input for further processing such as parsing or text mining. Tokenization is the process of demarcating and/or classifying sections of a string of input. The resulting tokens can then be passed on to some other form of processing.

### Example Methods and Systems

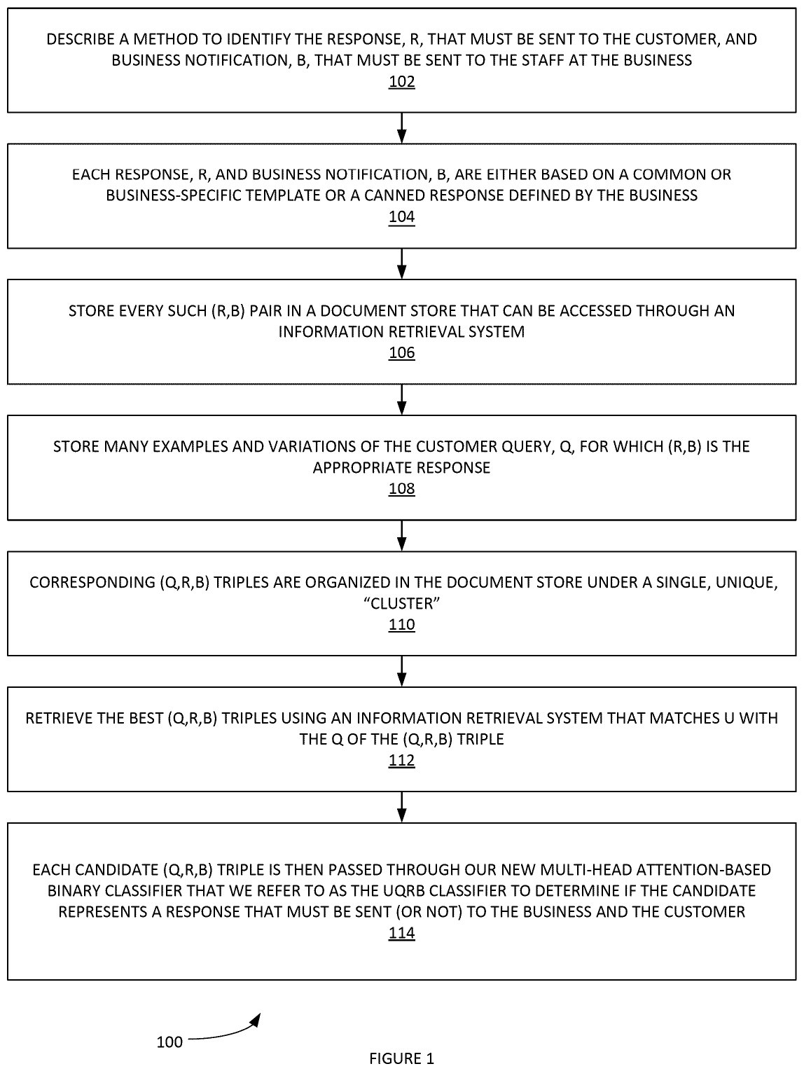

FIG. 1 illustrates an example process 100 for implementing a unified model that responds to an incoming customer message or request, according to some embodiments. Process 100 can be in accordance with any business-specific workflows and call handling policies.

In step 102, given a user (e.g. a customer, etc.) message, U, process 100 describes a method to identify the response, R, that must be sent to the customer, and business notification, B, that must be sent to the staff at the business. Either one or both of these may be predicted as empty by the model, which would mean that no response needs to be sent to the customer upon receiving the message, U, or that no business notification needs to be sent to the staff, or both. It is noted that, in its simplest manifestation, U represents the most recent message sent by the customer to the business; in general, however, U represents a roll-up of the entire conversation session between customer and business, with all the previous sent and received messages, and including the most recent message from the customer to the business.

Each response, R, and business notification, B, are either based on a common or business-specific template (e.g. templates to share availabilities in response to appointment requests, or appointment confirmation messages, etc.) or a canned response defined by the business (e.g., answers to Frequently Asked Questions, or notifications to the business when a customer has indicated that they are running late etc.) in step 104.

Every unique (R,B) pair is a potential response to the input user message, U. Accordingly, in step 106, process 100 stores every such (R,B) pair in a Document Store that can be accessed through an Information Retrieval System (e.g., SOLR, Lucene etc.). Alongside each (R,B) pair, process 100 also stores many examples and variations of the customer query, Q, for which (R,B) is the appropriate response in step 108.

The corresponding (Q,R,B) triples (e.g. with all the different Q's but same (R,B) are organized in the Document Store under a single, unique, “cluster” in step 110. Thus, there will be as many clusters as there are unique (R,B) pairs for a given business. Given U, process 100 can first retrieve the best (Q,R,B) triples using an information retrieval system that matches U with the Q of the (Q,R,B) triple in step 112. Each (Q,R,B) triple essentially represents a candidate response to U in the sense that the B is the notification to the staff at the business and the R is the response to be sent to the user/customer. The U together with each candidate (Q,R,B) triple is then passed through our new multi-head attention-based binary classifier that is referred to as the UQRB Classifier to determine if the candidate represents a response that must be sent (or not) to the business and the customer in step 114.

### Example UQRB Classifier

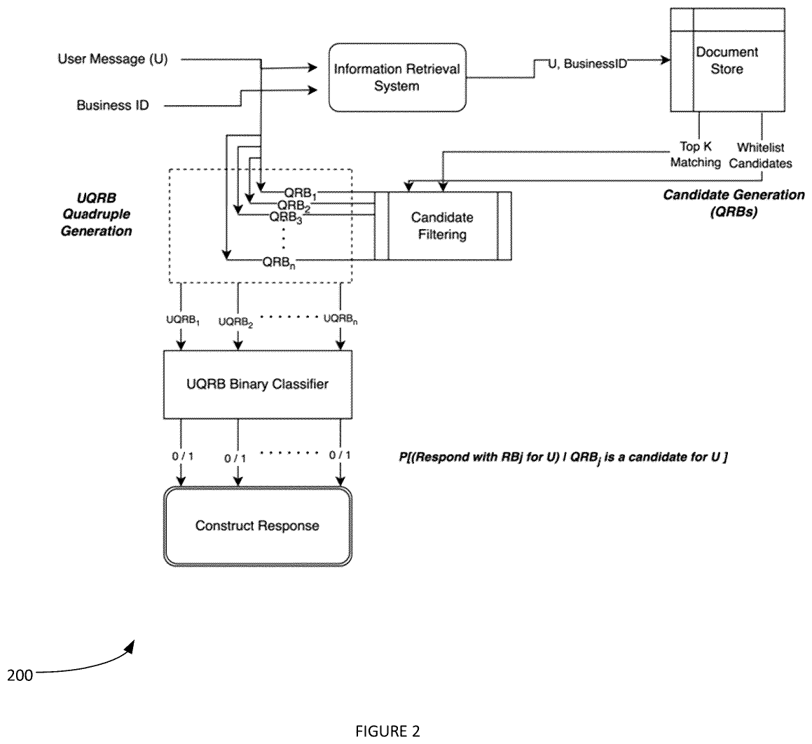

FIG. 2 illustrates an example of UQRB classifier 200, according to some embodiments. Process 200 shows these steps as a pipeline.

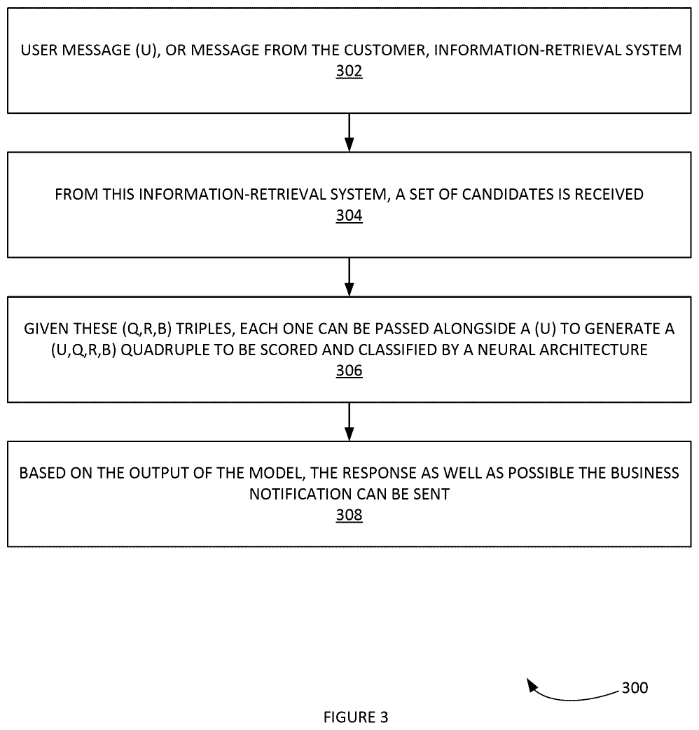

FIG. 3 illustrates an example process 300 for implementing a UQRB classifier, according to some embodiments. Process 300 can be integrated with UQRB classifier 200. In step 302, the user message (U), or message is obtained from the customer, information-retrieval system (e.g. Solr, etc.).

From this information-retrieval system, a set of candidates is received in step 304. These candidates take on the form of a triplet that contain a query (Q), response to the customer (R), and notification to the business (B). These (Q,R,B) triples that are stored in the information retrieval system come from three (3) different sources, including, inter alia: historical data, question-answer pairs provided by the business, and generative AI that is used to augment the dataset.

Given these (Q,R,B) triples, each one can be passed alongside a (U) to generate a (U,Q,R,B) quadruple to be scored and classified by a neural architecture in step 306. Based on the output of the model, the response as well as possible the business notification can be sent in step 308.

Candidate generation for the UQRB classifier and process 300 is now discussed.

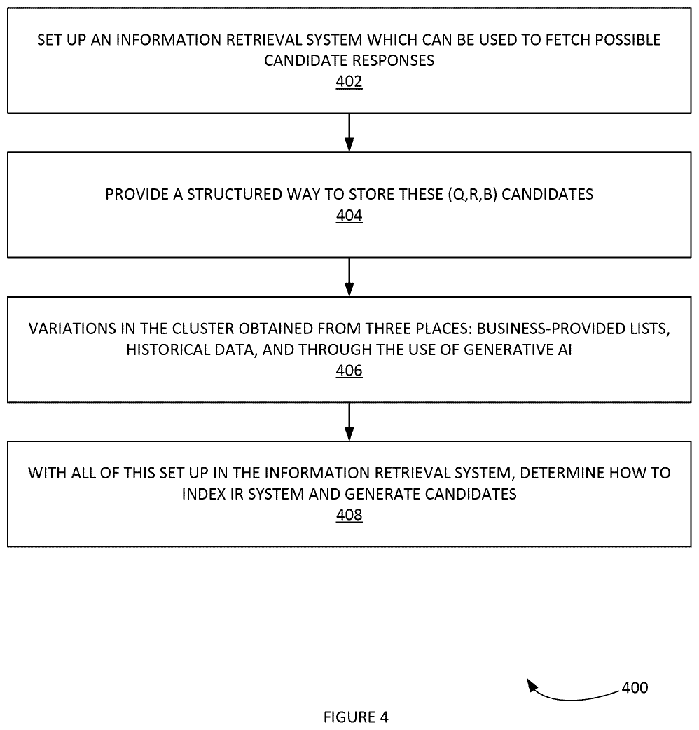

FIG. 4 illustrates an example process 400 for candidate generation, according to some embodiments. It is noted that the purpose of this (U,Q,R,B) infrastructure described is to determine what response to send, given a customer message as input. This response is a combination of the response, (R), to the customer, and the business notification, (B), which is sent to the business. In this way, the end result of passing a customer message, (U), through this infrastructure, is to determine what (R,B) pair to send as a response to the customer message, U. In order to accomplish this, the first step is to create a process to generate candidates with process 400.

In order to generate candidates, in step 402, process 400 sets up an information retrieval system (e.g. Solr, etc.) which can be used to fetch possible candidate responses.

Process 400 can provide a structured way to store these (Q,R,B) candidates. Accordingly, in step 404, the (Q,R,B) triples are stored in a cluster based on their unique (R,B). The variations in the cluster are in the form of the values (Q) can take.

This can be obtained from three places: business-provided lists, historical data, and through the use of Generative AI in step 406. A business provides a list of sample queries, Q, and the corresponding response, R, and business notification, B, to send. The historical chat logs are scanned to generate queries, Q, and corresponding (R,B) s sent in the past. This historical data then augments the current business provided lists. The business provided Qs are rephrased using Gen AI to enhance the number of variations of Q. For example, each business provided (Q,R,B) triple can be enhanced to contain (e.g. twenty-five (25)), AI-generated rephrasings of its question/query. Another key factor to remember is that these candidates are organized by (R,B), with multiple questions/queries (e.g. business provided, historical, or AI-generated) associated with the same unique (R,B).

With all of this set up in the information retrieval system, process 400 determines how to index this IR system and generate candidates in step 408. An example process of step 408 can be as follows. First, process 400 can query this IR system with the given customer message, U. Process 400 retrieves the k highest matching (Q,R,B) triples each having a unique (R,B). This means that of all the (Q,R,B) candidates chosen, all of them can have a unique (R,B). This number of candidates chosen, k, is a maximum. If the IR system retrieves less than k candidates with unique (R,B)s, then that is all that is chosen. So now, there can be a list of candidates (Q,R,B)s based on their match with the given customer U. In this way, the rephrasing of questions/queries by Generative AI can be important. In doing so, the data is augmented such that the pool of data to select candidates from is more abundant and diverse. In particular, the AI-generated question may be a better match with U, than the original Q provided by the business. Thus, the performance of the model is improved by improving the quality of the selection of candidates.

Keywords-based filtering is now discussed.

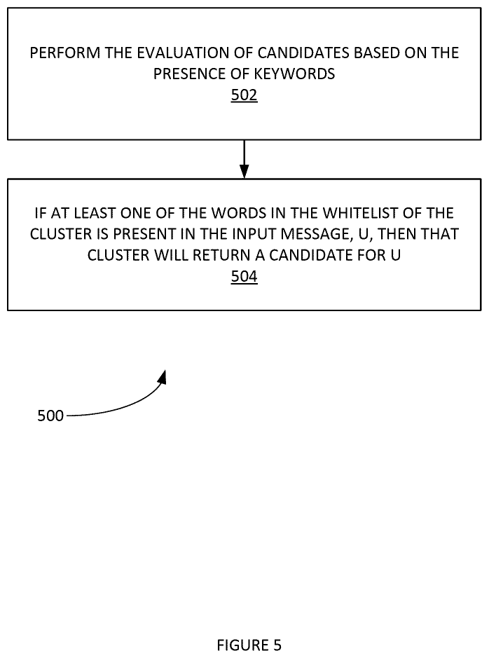

FIG. 5 illustrates an example process 500 for keywords-based filtering, according to some embodiments. Another important addition to candidate generation is the use of keywords. For the candidate selection phase, in addition to the candidates selected from the IR system which have unique (R,B) s, there is another step which has a higher priority. In step 502, process 500 performs the evaluation of candidates based on the presence of keywords. In addition to all the question/query variations, each cluster contains three sets of keywords: a whitelist, a type 1 blacklist, and a type 2 blacklist. These sets of keywords help with the further selection and filtering of candidates.

If at least one of the words in the whitelist of the cluster is present in the input message, U, then that cluster will return a candidate for U in step 504. Blacklists in contrast provide a mechanism to filter candidates based on keywords. If any of the keywords in the type 1 blacklist are present in the input message, U, then that cluster will be filtered out of the candidate list. It is noted that if no keywords in the type 2 blacklist match any word in the input message, U, then that cluster will not be selected as a candidate.

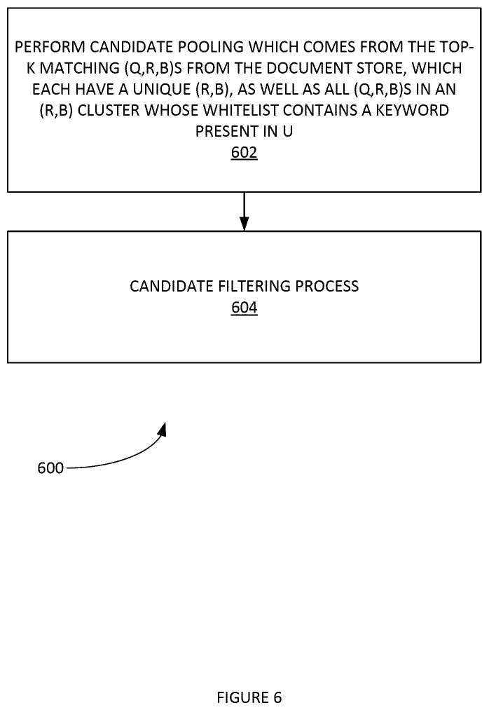

FIG. 6 illustrates an example process 600, according to some embodiments. In step 602, process 600 performs candidate pooling which comes from the top-k matching (Q,R,B)s from the document store, which each have a unique (R,B), as well as all (Q,R,B)s in an (R,B) cluster whose whitelist contains a keyword present in U. This “(R,B) cluster” is just the list of all (Q,R,B)s which have the same (R,B), but different Qs.

Now that all the possible candidates are pooled, the next step (step 604) is a candidate filtering process. This is done with the blacklists discussed earlier. Any of the (Q,R,B) candidates, which come from IR matching or whitelist are passed into this candidate filtering phase, where the blacklist is applied. If any keyword in the type 1 blacklist, at the (R,B) cluster level, is present in the user message, U, then that candidate is filtered out and cannot be sent to the model. The same is true for the type 2 blacklist except it can suppress/filter the candidate based on if none of the keywords are present.

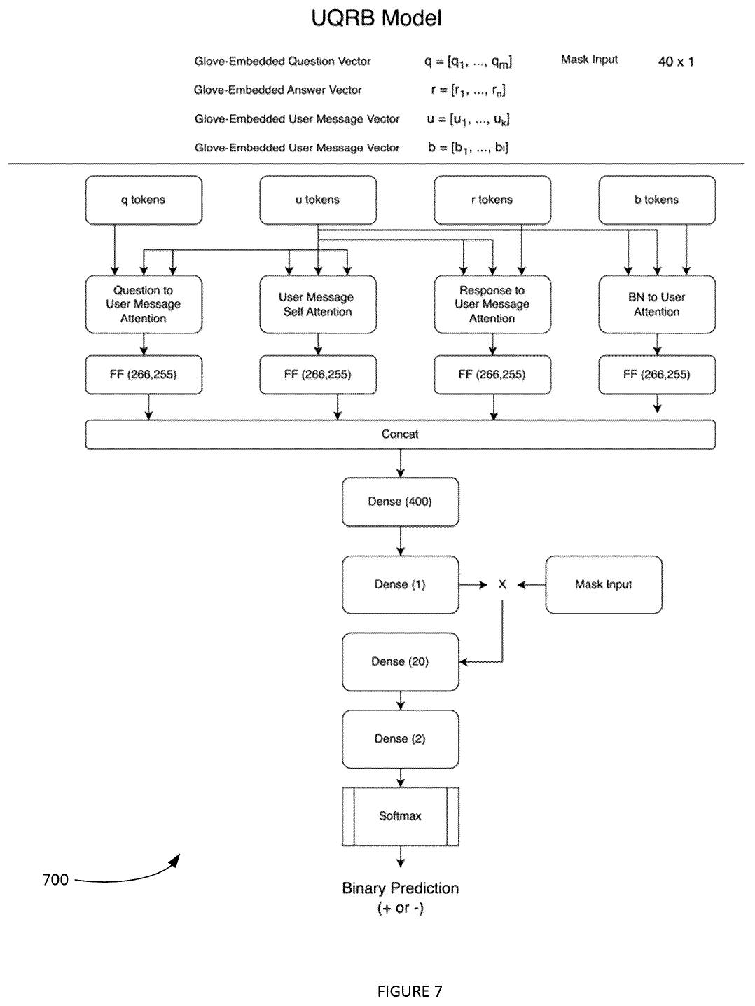

FIG. 7 illustrates an example UQRB Network Architecture 700, according to some embodiments. After this candidate filtering step through the use of blacklist keywords, UQRB Network Architecture 700 obtains a list of candidate (Q,R,B)s that can be passed alongside the U into our model. This model is a binary classifier which will output a probability (between 0 and 1). This can be interpreted as the probability that (R,B) is the correct response to U, given that (Q,R,B) is selected as a candidate for U.

UQRB Network Architecture 700 provides the network architecture for the UQRB model. UQRB Network Architecture 700 starts with a vector representation for each token in U, Q, R and B, for example using 200-dimensional GloVe Embeddings. These embeddings are then augmented by DAGFrames which are custom word-level representations that extend off the shelf pre-trained word embeddings, such as GloVe, with business specific representations for the token. For example, in some instantiations, UQRB Network Architecture 700 extends a 200-dimensional GloVe embedding to a 255-dimensional vector representation using DAGFrames and business dictionaries. For any message (e.g. one of U, Q, R or B) the representation will be 40 “tokens” long. If the message is too short, it will be padded with 0s, and if the message is too long, it will be truncated such that all inputs are 40×255. At the highest level, the model is inspired by a Multi-head Attention network. However, where the Transformer is used to encode a single input message, our UQRB model uses the network to simultaneously encode 4 different messages: U, Q, R and B. The encodings from our model enable both cross and self-attention across all these 4 messages.

Now these DAGFrame-augmented vector representations are passed through Multi-head Attention Layers. Each Multi-head Attention layer requires three (3) inputs, a query, key and value. In each head of the Multi-head Attention layer, there is first a linear projection. Then a dot product is computed between the query and key and the result is scaled. This result is then passed through a SoftMax layer and interpolated with the value vector. In our architecture, there are 4 branches, each with a Multi-head Attention Layer, with for example 5 heads. For the Q Branch (leftmost), the Q vector is used as the query, while the U vector is used as the key and value. This can be the Question to User Cross Attention. The 2nd branch is the U (2nd from the left). For the U, this is a self-attention, so the query, key, and value are all U. The 3rd branch is the R (3rd from the left), and the query is the R vector, while the key and value are again the U vector. The pattern is the same for the last branch (B), where the B vector is the query, and the U vector is the key and value. In the end, the output is the same dimension as the initial vector representations (40×255). Now, each of the outputs of the respective attention layers are added with the representations before the attention layer and then layer normalized. Then each of these representations are passed through a feed forward network which is just 2 consecutive dense layers, for example of sizes 266 and 255, followed by an add+norm, where the input to the feed forward layer is added to the output of the 2 dense layers, and the result is then again layer normalized. Now, the output from the feed forward network will be of size 40×255. The next step is to concatenate these representations into a single representation of size 40×1020. This representation will then be reduced to a 1×2 vector with the following steps. First, there is another dense layer of size 400, followed by another dense layer of size 1. Now the representation is of size 40×1. This is then multiplied by a 40×1 mask that is taken as input. The purpose of this mask is to ensure any computations on tokens that were to be 0 padded are not used in the final result. The mask is then essentially a 40×1 vector of 1's followed by 0s.

The result after multiplying by the mask is then transposed to achieve a 1×40 representation. Now there is another dense layer of size 20 followed again by a dense layer of size 2. Now that the representation is 1×2, a SoftMax is applied, and the result is a probability.

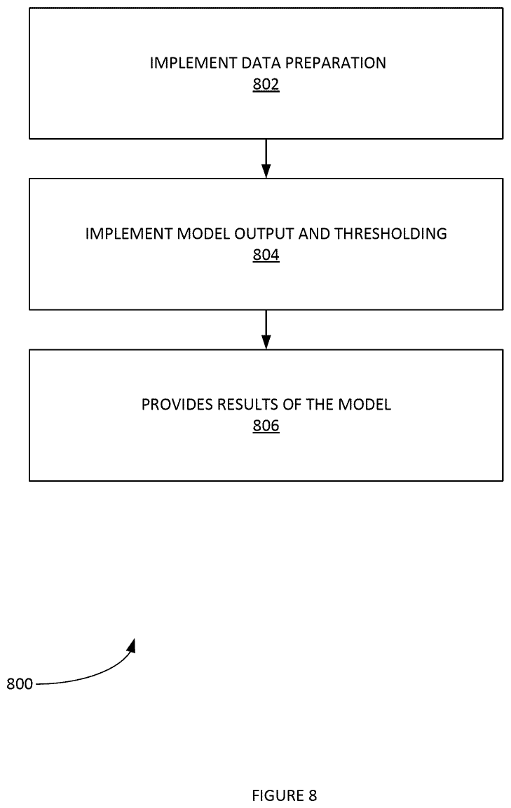

FIG. 8 illustrates an example process for Model Training, according to some embodiments. In step 802, process 800 implements Data Preparation. In order to train the model, the first step is to construct the data set (e.g. the (U,Q,R,B)) quadruples that are to be classified. These quadruples are generated both from historical data as well as business provided examples.

Process 800 obtains the chronologically ordered raw conversation data and business notifications data from the historical logs. To generate the (Q,R,B) data, that is to be appended to the U later, first the data is bundled according to the sender such that the data is now a sequence of user and bot turns and their corresponding messages, events, etc. The next step is to look at the previous user message block in order to associate the bot action with the corresponding user turn. The next step is to clean and encode the messages and responses. The user message is encoded to mask out personal details such as phone numbers, voicemails, and emails. The response block, R, is also similarly encoded, with an additional task of being marked as the string (EMPTY) if there was no response. The same is true for the Business Notification block, B.

Now this data is published to the Document Store. In particular, all customer queries (Q) with at least one response, business notification, or FAQ response, are pushed into the Document Store as historical candidates, while those messages with none of the above are cleaned (set Business Notification, Response, and FAQ to (EMPTY)) and then pushed into the Document Store.

Now with this data into the Document Store, the next step is to generate quadruples from these triples. In the Document Store, all message blocks/triples with at least one of Response, Business Notification, or non-empty FAQ are marked as possible candidates for training. Of these candidate triples (Q′, R′, B′), there is a query into the Document Store and the top k responses sorted by highest match, say 100, are fetched. For each of these matches, a hash key is also based on the following conditions.

First, if there is a FAQ response, then the hash key is the FAQ response+Business Notificationstring.

Otherwise, if there is a non-empty business notification, B, then just that B is used as the hash key.

Finally, if there is no Business Notification or FAQ Response, the Response is used.

Additionally, all responses that either have the same FAQ response or have an empty FAQ response but also have the same Business Notification or Response are grouped by their hash key and the candidate triple which has the highest matching score is chosen as a “representative” for the group.

After these are taken into account, for each of the possible 100 triples (Q,R,B) that match with the candidate (Q′,R′, B), there needs to be a determination on whether or not the ground truth is positive or negative. The way this is done is by comparing the hash keys of both triples. If the hash keys are the same for each triple, then it is a positive match otherwise it is negative. In essence, the hash key is the accumulation of the response, Business Notification and FAQ response and so if they match it means the response, Business Notification and FAQ response were also the same, and so the two messages are positively matched.

In step 804, process 800 implements Model Output and Thresholding. The output of the model as described earlier is a probability that the given user message, U, is associated with the (Q,R,B), given a single (U,Q,R,B) quadruple. In fact, the output is just a prediction of the likelihood that (R,B) is the response for a given user message, U, given that there exists a query, Q, which did result in the sending of the (R,B) pair. More concretely, the output layer of the UQRB models a posterior probability that the (R,B) pair is a correct response to the input user message, U, given that the (Q,R,B) is returned as a candidate for U by the IR system. It is important to remember that many (U,Q,R,B) quadruples are generated as candidates for the model to evaluate. However, this does not mean that there is only one correct (R,B) response to send, or that there even needs to be a response. Rather each candidate must be evaluated on its own based on the output of the model for that (U,Q,R,B). If there are multiple candidate responses (R,B) s whose output from the model is above the respective threshold, then the responses are composed together and sent.

However, there is not one single threshold used for every (U,Q,R,B), but rather multiple. In fact, since the problem reduces to determining whether a given U should have the response, (R,B), it is important to have a distinct threshold for each unique (R,B). In essence, this means some (R,B) response pairs require a higher threshold to send. For example, a response where each word is common should require a higher threshold to send since process 800 knows that rearranging common words in a sentence can dramatically change its meaning. On the other hand, responses that contain rarer words can have a lower threshold, since it is less likely to be confused with a response that has a different meaning. For other applications this threshold generation can be done using any characteristic of the (R,B), but the important thing to understand is that there is not a standard threshold.

What this means is that there is a custom function for each (R,B), which takes in a U and Q and determines whether or not that U belongs to the universal set of messages which have response (R,B).

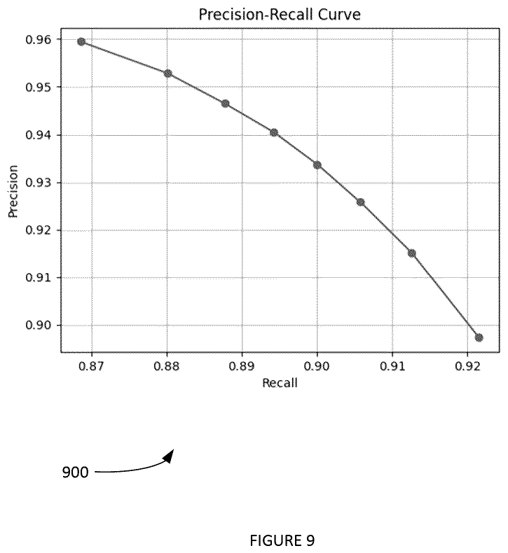

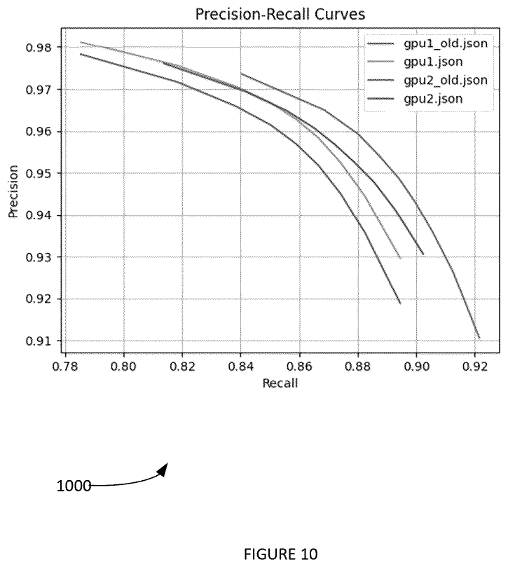

In step 406, process 400 provides results of the model. After training, FIGS. 9 and 10 illustrate example Precision-Recall Curves, according to some embodiments and provided by way of example and not of limitation. As can be seen in FIG. 9, there were many thresholds that satisfy a 90/90 requirement for both precision and recall. In fact, we see one point which has a precision of around 93.3% and a recall of 90%. In FIG. 10, four (4) separate pr curves generated from different training instances are shown.

By way of example and not of limitation, the following example benefits are discussed. The benefits of a UQRB classifier-based response selection are now discussed. There are many benefits of the UQRB Architecture. One of the main benefits is that when a new business comes on board, this existing model infrastructure will work. There may be no need to retrain the model for each new business that is added to the platform. For a new business, they will only need to generate a few (Q,R,B) triples, and the model and response generation will work from there. Therefore this model allows for few-shot customization on a business level. This can allows for existing businesses to update their (Q,R,B)s, without needing to retrain the model.

Another benefit is that this allows for the simultaneous determination of response between the AI and user, (R) and the AI and business, (B). The architecture can be like a Large Language Model, that is specialized for front desk communication.

A last benefit is that this architecture allows for naturally composing new responses from multiple (Q,R,B)s. These composite responses are easily generated for multi-intent user messages in this structure. Since this structure passes multiple possible (Q,R,B) triples alongside the U, if multiple (Q,R,B)s are classified as positive, there is a natural way to deal with this.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by this United States patent:

1. A computerized-method for implementing a unified model that responds to an incoming customer message or request, comprising:
given a user input message, U:
identifying a response, R, that is to be sent to the customer,
identifying a business notification, B, that is to be sent to the staff at the business,
basing the response, R, and the business notification, B, on a common template or a business-specific template or a canned response defined by the business;
wherein a unique (R,B) pair comprises a potential response to the input user message, U,
storing a plurality of (R,B) pairs in a Document Store that is accessible through an Information Retrieval System;
alongside the plurality of (R,B) pairs, storing a set of examples and a set of variations of the customer query, Q, for which each (R,B) pair of the plurality of (R,B) pairs is the appropriate response;
given a query, Q:
providing a plurality of corresponding (Q,R,B) triples, wherein all the different Q's but same (R,B) are organized in the Document Store under a single, unique, cluster;
wherein given user input message, U, retrieving a best (Q,R,B) triple using an information retrieval system that matches user input message, U with the Q of the (Q,R,B) triple; and
passing the user input message, U together with each candidate (Q,R,B) triple through a multi-head attention-based binary classifier to determine if the candidate represents a response that is to be sent to the business and the user.

2. The computerized method of claim 1, wherein U or R is predicted as empty by the unified model.

3. The computerized method of claim 1, wherein no response needs to be sent to the customer upon receiving the message, U.

4. The computerized method of claim 3, wherein U represents a most recent message sent by the customer to the business.

5. The computerized method of claim 4, wherein U represents a roll-up of the entire conversation session between customer and business, with all the previous sent and received messages, and including the most recent message from the customer to the business.

6. The computerized method of claim 1, wherein the business-specific template comprises a plurality of templates to share availabilities in response to appointment requests, or appointment confirmation messages.

7. The computerized method of claim 6, wherein the canned response defined by the business comprises a plurality of answers to Frequently Asked Questions or a plurality of notifications to the business when a customer has indicated that they are running late.

8. The computerized method of claim 7, wherein there as many clusters as there are unique (R,B) pairs for a given business.

9. The computerized method of claim 8, wherein each (Q,R,B) triple represents a candidate response to U in the sense that the B is the notification to the staff at the business and the R is the response to be sent to the user.

10. The computerized method of claim 9, wherein the multi-head attention-based binary classifier comprises a UQRB Classifier.

11. The computerized method of claim 10 further comprising:
obtaining the user input message U from an information-retrieval system.

12. The computerized method of claim 11 further comprising:
receiving from the information-retrieval system, a set of candidates, wherein the set of candidates takes on the form of plurality of corresponding (Q,R,B) triples.

13. The computerized method of claim 12, wherein the plurality of corresponding (Q,R,B) triples are stored in the information retrieval system come from three (3) different sources, comprising: a historical data, a question-answer pairs provided by the business, and a generative AI that is used to augment the dataset.

14. The computerized method of claim 13, wherein for each (Q,R,B) triple of the plurality of corresponding (Q,R,B) triples, each (Q,R,B) triple is passed alongside a (U) to generate a (U,Q,R,B) quadruple to be scored and classified by a neural architecture.

15. The computerized method of claim 14, wherein based on the output of the unified model, the response, R, as well as business notification, B, are electronically sent to the user.
